(19) United States
(12) Patent Application Publication
(10) Pub. No.: US 2006/0191514 A1
(43) Pub. Date: Aug. 31, 2006

(54) Accumulator fuel injection system

(76) Inventor: Takashi Kaneko, Sagamihara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/360,913

(22) Filed: Feb. 24, 2006

(30) Foreign Application Priority Data
Feb. 25, 2005 (JP) 2005-051885

(51) Int. Cl. F02M 63/00

(52) U.S. Cl. 123/447; 123/456

(57) ABSTRACT

An accumulator fuel injection system can be provided with which fuel pressure pulsation in the common rail caused by fuel injection can be suppressed by extremely simple means with a low cost system without using an electronic control device and so on. The accumulator fuel injection system having a common rail for supplying high pressure fuel accumulated in an accumulating room of said common rail through high pressure fuel outlets provided equally spaced along the longitudinal direction of said common rail to the fuel injection valve of each cylinder at predetermined injection timing is composed such that the distance from an end of the accumulating room where a pressure wave generated therein is reflected from to a high pressure fuel outlet adjacent to said end (L₁ or L₂) is determined in a range of (N+0.25) times to (N+0.375) times the pitch length L of said equally spaced high pressure fuel outlets each corresponding to each cylinder, N being a nonnegative integer.

### BACKGROUND OF THE INVENTION

1. Field of the Invention

The present invention relates to an accumulator fuel injection system with a common rail which is applied to a diesel engine, high pressure fuel being accumulated in the common rail and supplied at a constant interval to the injection nozzle of each cylinder from high pressure fuel outlet ports disposed at a constant spacing in the common rail.

2. Description of the Related Art

Accumulator fuel injection systems in which high pressure fuel accumulated in a common rail is supplied to the injection nozzle of each cylinder at determined injection timing are in heavy usage in recent years in diesel engines.

In an accumulator fuel injection system like this, pressure pulsation occurs in the common rail induced by the opening and closing of the injection nozzles. The outlet ports connecting to injection pipes are arranged with the same pitch in the common rail and the fuel injection interval is also the same for each cylinder, so a standing wave resides in the common rail, and this standing wave may affect the next injection.

In Japanese Laid-Open Patent Application No.11-159372 is disclosed a means to eliminate the influence of the pulsation of fuel pressure in the common rail.

According to the disclosure, by use of an electronic control device, a difference of injection pressure to be corrected is determined based on the set value of fuel injection quantity, injection pressure of fuel is determined according to the pressure to be corrected with the injection valve opening period being reflected for the correction, and injection valve opening periods are controlled taking into consideration the reflection of fuel pressure so that quantity of fuel optimal for the operating condition of the engine and for pulsating condition of fuel pressure is injected even when fuel pressure pulsation occurs in the fuel injection line and the reflection wave of fuel synchronizes with the injection of the next cylinder.

However, there is a problem in the art disclosed in the Japanese Laid-Open Patent Application No.11-159372 that, as a difference of injection pressure to be corrected is determined based on the set value of fuel injection quantity and the opening period of the injection valve is controlled by electronic control device based on the corrected injection pressure taking the reflection wave of the fuel pressure into consideration, the program for calculation and control is inevitably complicated and the cost of the system is increased for providing the electronic control device.

### SUMMARY OF THE INVENTION

The object of the present invention is made in light of the prior art and the object is to provide an accumulator fuel injection system with which fuel pressure pulsation in the common rail caused by fuel injection can be suppressed by extremely simple means with a low cost system.

To attain the object, the present invention proposes an accumulator fuel injection system having a common rail for supplying high pressure fuel accumulated in an accumulating room of the common rail to the fuel injection valve of each cylinder through high pressure fuel outlets provided equally spaced along the longitudinal direction of the common rail at predetermined injection timing, wherein a distance from an end of the accumulating room where a pressure wave generated therein is reflected from to a high pressure fuel outlet adjacent to the end is determined in a range of (N+0.25) times to (N+0.375) times the pitch length L of the equally spaced high pressure fuel outlets each corresponding to each cylinder, N being a nonnegative integers.

According to the invention, as the distance from an end of the accumulating room to a high pressure fuel outlet nearest to the end is in a range of (N+0.25) times to (N+0.375) times the pitch length L of the high pressure fuel outlets, reflected pressure wave from the end of the accumulating room have phases different from a pressure wave advancing toward the end also in a wave of shorter wave length, that is, in a second and third harmonic wave, and advancing pressure wave is counteracted by the reflecting wave in waves other than the fundamental wave resulting in effectively suppressed fuel pressure pulsation in the accumulating room.

Therefore, occurrence of irregular fuel injection, deviation in injection timing, and lowering in engine performance caused by these nonconformities in fuel injection can be prevented.

The present invention also proposes an accumulator fuel injection system having a common rail for supplying high pressure fuel accumulated in an accumulating room of the common rail to the fuel injection valve of each cylinder through high pressure fuel outlets provided equally spaced along the longitudinal direction of the common rail at predetermined injection timing, wherein distance L₁ from an end of the accumulating room where a pressure wave generated therein is reflected from to a high pressure fuel outlet adjacent to the end is ½ times the pitch length L of the equally spaced high pressure fuel outlets each corresponding to each cylinder, i.e. L₁=½·L, and distance L₂ from the other end of the accumulating room to a high pressure fuel outlet adjacent to the other end is 3/2 times the pitch length L, i.e. L₂= 3/2·L.

According to the invention, as distance L₁ from an end of the accumulating room to a high pressure fuel outlet adjacent to the end is ½ times the pitch length L of the high pressure fuel outlets, i.e. L₁=½·L, the reflected pressure wave of the fundamental wave reflected from the end of the accumulating room has a phase adverse to the fundamental pressure wave advancing toward the end, and the reflected wave and advancing wave counteract to each other, resulting in suppression of the fuel pressure pulsation in the accumulating room.

Further, at the other end of the accumulating room, as distance L₂ from the other end to a high pressure fuel outlet adjacent to the other end is 3/2 times the pitch length L of the high pressure fuel outlets, i.e. L₂= 3/2·L, the reflected pressure wave of the fundamental wave reflected from the other end has a phase adverse to the fundamental pressure wave advancing toward the end, and the reflected wave and advancing wave counteract to each other, resulting in suppression of the fuel pressure pulsation in the accumulating room. This is a case to aim the suppression of mainly fundamental wave among in the wave generated in the accumulating room by fuel injection.

Further, the present invention proposes an accumulator fuel injection system having a common rail for supplying high pressure fuel accumulated in an accumulating room of the common rail to the fuel injection valve of each cylinder through high pressure fuel outlets provided equally spaced along the longitudinal direction of the common rail at predetermined injection timing, wherein a pressure reflecting member having a plurality of projections is provided at an end part of the accumulating room where a pressure wave generated therein is reflected from such that the projection is directed toward the accumulating room.

In the invention, it is preferable to compose as follows: (1) The pressure reflecting member has a plurality of annular projections formed such that each annular projection is concentric around the center of the accumulating room and faces toward the accumulating room.

(2) The pressure reflecting member has a plurality of acerose or needlelike projections formed such that each projection faces toward the accumulating room.

According to the invention, when the pressure wave generated in the accumulating room and propagating in the longitudinal direction along the accumulating room collides against a plurality of the projections formed in annular projections or acerose or needlelike projections at the end of the pressure reflecting member, the wave collided with each of the projections interfere with each other and energy of the pressure wave is decreased and fuel pressure pulsation in the accumulating room is suppressed.

Further, the present invention proposes an accumulator fuel injection system having a common rail for supplying high pressure fuel accumulated in an accumulating room of the common rail to the fuel injection valve of each cylinder through high pressure fuel outlets provided equally spaced along the longitudinal direction of the common rail at predetermined injection timing, wherein a relief valve is provided at an end of the accumulating room for adjusting the pressure therein and a pressure sensor is provided at the other end of the accumulating room for detecting the pressure therein, and a tapered portion projecting toward the accumulating room is formed to one or both of the relief valve and the pressure sensor.

According to the invention, pressure wave generated in the accumulating room and propagating in the direction along the accumulating room to collides against the tapered projection formed at the end of the relief valve or the tapered projection formed at the end of the pressure sensor, then the pressure wave is reflected irregularly from the tapered projection, so the energy of the pressure wave is decreased and fuel pressure pulsation in the accumulating room is suppressed.

Further, the present invention proposes an accumulator fuel injection system having a common rail for supplying high pressure fuel accumulated in an accumulating room of the common rail to the fuel injection valve of each cylinder through high pressure fuel outlets at predetermined injection timing, wherein the high pressure fuel outlets each corresponding to each cylinder are positioned unequally spaced such that at least one of distances between adjacent high pressure fuel outlets is determined in a range of (N+0.25) times to (N+0.375) times the shortest distance L between adjacent high pressure fuel outlets, N being a nonnegative integers.

According to the invention, as distances between adjacent high pressure fuel outlets in the common rail are determined in a range of (N+0.25) times to (N+0.375) times the shortest distance L between adjacent high pressure fuel outlets, the pressure wave generated at a high pressure fuel outlet has a phase different from the pressure wave generated at another high pressure fuel outlet, these pressure waves counteract each other, and fuel pressure pulsation in the accumulating room is suppressed.

Therefore, occurrence of irregular fuel injection, deviation in injection timing, and lowering in engine performance caused by these nonconformities in fuel injection can be prevented.

As has been described in the forgoing, according to the present invention, by determining a distance from an end of the accumulating room to a high pressure fuel outlet adjacent to the end to be in a range of (N+0.25) times to (N+0.375) times the pitch length L of the high pressure fuel outlets, the wave reflected from the end part of the accumulating room have a phase different from the phase of the wave advancing toward the end part in a wider range of harmonic waves and fuel pressure pulsation in the accumulating room can be suppressed.

According to the present invention, by allowing the pressure wave propagating in the longitudinal direction in the accumulating room to collide against a plurality of the projections of the pressure reflecting member located at the end part of the accumulating room, the reflection wave interferes with each other, the energy of the pressure wave is weakened, and fuel pressure pulsation in the accumulating room is suppressed.

Further, according to the present invention, the pressure wave propagating in the longitudinal direction in the accumulating room collides with tapered projection located at the end part of the accumulating room to be reflected irregularly from the tapered portion, and the energy of the pressure wave is weakened resulting in decreased fuel pressure pulsation in the accumulating room.

Therefore, fuel pulsation in the accumulating room of the common rail can be suppressed by extremely simple means with a low cost system, and occurrence of irregular fuel injection, deviation in injection timing, and lowering in engine performance caused by these nonconformities in fuel injection can be prevented without using such an electronic control device as used in the prior art.

### BRIEF DESCRIPTION OF THE DRAWINGS

FIG. 1 is a longitudinal sectional view of the common rail of the first embodiment of the accumulator fuel injection system for a V-type diesel engine according to the present invention.

FIG. 2 is a longitudinal sectional view of the common rail of the first embodiment of the accumulator fuel injection system for an in-line diesel engine according to the present invention and corresponds to FIG. 1.

FIG. 3 show the second embodiment of the invention, FIG. 3A is an enlarged view of the end part of the common rail, and FIG. 3B is a view in the direction of the arrow Z in FIG. 3A.

FIG. 4 show the third embodiment of the invention, FIG. 4 A is an enlarged view of the end part of the common rail, and FIG. 4B is a view in the direction of the arrow Y in FIG. 4A.

FIG. 5 show the fourth embodiment of the invention, FIG. 5 A is an enlarged view of the end part of the common rail, and FIG. 5B is a view in the direction of the arrow W in FIG. 4A.

FIG. 6 is a drawing (case 1) showing the relation between the distance from the end of the pressure sensor to the high pressure fuel outlet nearest to the end and reflecting wave of the fundamental pressure wave of fuel pressure pulsation in the accumulation room in the case of the first embodiment.

FIG. 7 is a drawing (case 2) showing the second harmonic of the pressure wave.

FIG. 8 is a drawing (case 3) showing the third harmonic of the pressure wave.

FIG. 9 is a longitudinal sectional view of the common rail of the fifth embodiment of the accumulator fuel injection system for an in-line diesel engine according to the present invention.

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

### First Embodiment

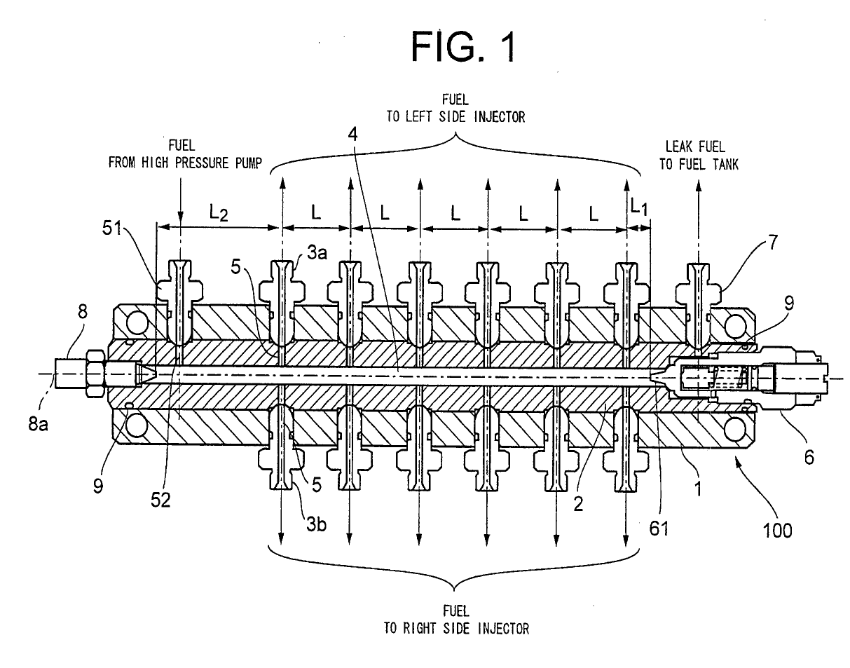

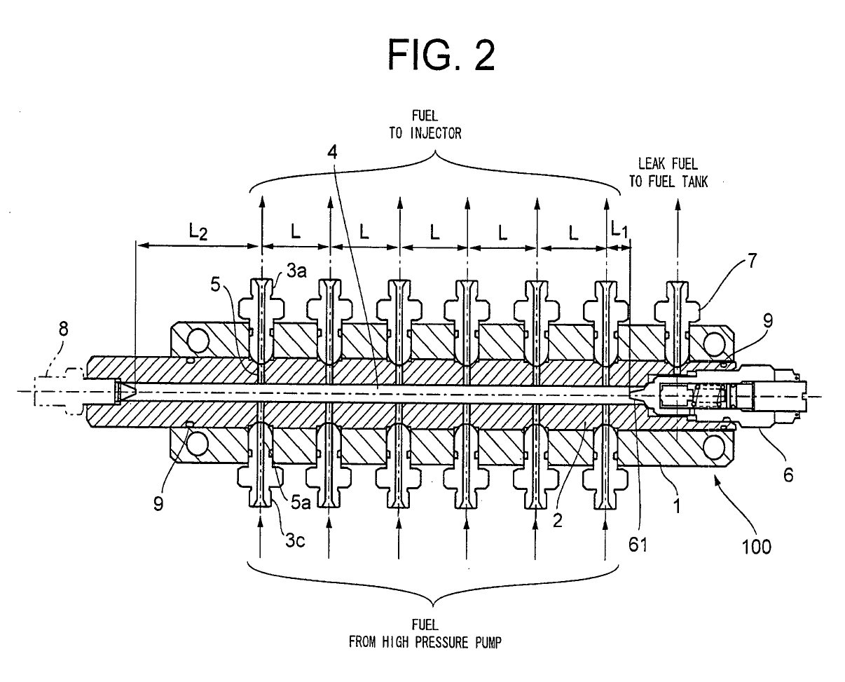

FIG. 1 is a longitudinal sectional view of the common rail of the first embodiment of the accumulator fuel injection system for a V-type diesel engine according to the present invention, and FIG. 2 is a longitudinal sectional view of the common rail of the first embodiment of the accumulator fuel injection system for an in-line diesel engine according to the present invention.

In the common rail of the accumulator fuel injection system of a 12-cylinder V-type diesel engine shown in FIG. 1, reference numeral 100 is a common rail consisting of an internal tube 2 having a accumulating room 4 extending in the longitudinal direction inside thereof and an external tube 1 into which the internal tube 2 is fitted together by insertion.

Reference numeral 3a represents outlet connectors connecting to fuel injection pipes (not shown in the drawing) of left side six cylinders (may be right side six cylinders), the number of the connectors is the same as that of the left side cylinders (6 cylinders in the drawing), and the connectors are screwed liquid-tight into the external tube 1 of the common rail 100 at the same spacing L along the longitudinal direction thereof.

Reference numeral 3b represents outlet connectors connecting to fuel injection pipes (not shown in the drawing) of right side six cylinders (may be left side six cylinders), the number of connectors is the same as that of the right side cylinders (6 cylinders in the drawing), and the connectors are screwed liquid-tight into the external tube 1 of the common rail 100 at the same spacing L along the longitudinal direction thereof.

Reference numeral 5 represents outlet passages of high pressure fuel connecting the accumulating room 4 to the outlet connectors 3a and 3b.

Reference numeral 51 is an inlet connector screwed liquid-tight into the external tube 1 at the periphery near an end thereof and connected to a high pressure pump not shown in the drawing by the medium of a fuel inlet pipe (not shown in the drawing).

Reference numeral 52 is an inlet passage of high pressure fuel connecting the accumulating room 4 to the inlet connector 51.

Reference numeral 6 is a relief valve screwed liquid-tight into the internal tube 2 at an end thereof for adjusting the pressure in the accumulating room 4. Reference numeral 7 is a return connector screwed into the exterior tube 1 at the periphery near the end where the relief valve 6 is screwed into the internal tube 2. Fuel allowed to escape through the relief valve 6 is returned through the return connector 7 to a fuel tank not shown in the drawing.

Reference numeral 8 is a pressure sensor to detect the fuel pressure in the accumulating room 4, the fuel pressure detected by the pressure sensor is transmitted to a fuel injection control system not shown in the drawing by the medium of a cable 8a.

In the common rail of the accumulator fuel injection system of a 6-cylinder in-line diesel engine shown in FIG. 2, reference numeral 3c represents inlet connectors provided for each cylinder for introducing high pressure fuel from a high pressure pump (not shown in the drawing) into the accumulating room 4, which are provided instead of the inlet connector 51 of FIG. 1. The connectors 3c are the same in number to that of the cylinders (6 cylinders in the drawing), screwed liquid-tight into the exterior tube 1 on the periphery thereof, and connected to the high pressure pump by the medium of fuel inlet pipes not shown in the drawing. Reference numeral 5a are high pressure fuel inlets connecting the connectors 3c to the accumulating room 4.

The configuration other than that is the same as that of FIG. 1 and the same constituent members are indicated by the same reference numerals.

In the first embodiment of the invention, the high pressure fuel outlets 5 are arranged such that the distance L₁ from right side end of the accumulating room 4 to the high pressure fuel outlet adjacent to the right side end and L₂ from the left side end thereof to the high pressure fuel outlet adjacent to the left side end are in a range of (N+0.25) to (N+0.375) respectively in both cases of accumulator fuel injection system of the 12-cylinder V-type diesel engine of FIG. 1 and 6-cylinder in-line diesel engine of FIG. 6. The pressure wave propagating in the longitudinal direction thereof being reflected from the ends of the accumulating room 4, N being a nonnegative integer.

In the first embodiment of the invention, it is also suitable that the distance L₁ from the end of the relief valve 6 in the accumulating room 4 to the high pressure fuel outlets nearest to the relief valve 6 is half the array pitch L of the outlets 5, i.e. L₁=½·L and the distance L₂ from the end of the of the pressure sensor 8 in the accumulating room 4 to the high pressure fuel outlets 5 nearest to the pressure sensor 8 is 3/2 times the array pitch L of the outlets 5, i.e. L₂= 3/2·L.

Wave length of fuel pressure pulsation caused by fuel injection is 2L/m, where m is a nonnegative integer excluding zero.

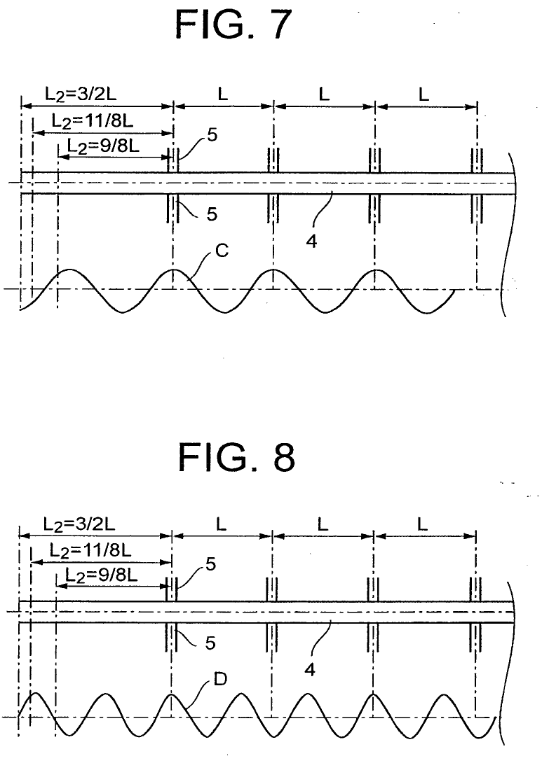

In FIG. 6 is shown the relation between the distance from the end of the pressure sensor 8 to the high pressure fuel outlet 5 nearest to the end and reflecting wave of the fundamental pressure wave of fuel pressure pulsation in the accumulation room. In FIG. 7 and 8 is shown the second (m=2) and third (m=3) harmonic of the pressure wave with three positions of the end of the pressure sensor being designated by chain lines respectively. In FIG. 6-8, parts same as those of FIG. 1-2 are indicated by the same reference numerals.

In FIG. 6 showing the fundamental wave, fuel pressure pulsation caused by fuel injection is indicated by A, and waves reflected from the end of the accumulating room, i.e. the end of the pressure sensor is indicated by B.

In FIG. 6, when L₂= 3/2·L, pressure pulsation A and reflected wave B balance each other out. When L₂= 11/8·L, pressure pulsation A is countered with reflected wave B in large part. When L₂= 9/8·L, pressure pulsation A is countered partly and amplified partly with reflected wave B.

In FIG. 8 showing third harmonic wave D, the wave D will be countered most effectively with its reflected wave (not shown in the drawing) when L₂= 3/2·L and when L₂= 9/8·L, as can be inferred from the example of FIG. 6.

As to second harmonic C shown in FIG. 7, the wave C will be countered most effectively with its reflected wave (not shown in the drawing) when L₂ is the middle between 11/8·L and 9/8·L.

Although FIG. 6-8 represent when N=1, above description is true when N is a nonnegative integer other than 1.

In the first embodiment, when the distance from an end of the accumulating room to a high pressure fuel outlet adjacent to the end is determined in a range of (N+0.25) times to (N+0.375) times the pitch length L of the high pressure fuel outlets, effect of counteraction of the fuel pressure pulsation with its reflected wave is decreased for the fundamental wave as shown in FIG. 6, but increased for the second and third harmonic wave. Therefore by determining L₁ and L₂ in a range as above, counteraction with reflected wave in pressure waves other than the fundamental pressure wave can be secured.

Therefore, fuel pressure pulsation in the accumulating room 4 is suppressed, and occurrence of irregular fuel injection, deviation in injection timing, and lowering in engine performance caused by these nonconformities in fuel injection can be prevented.

### Second Embodiment

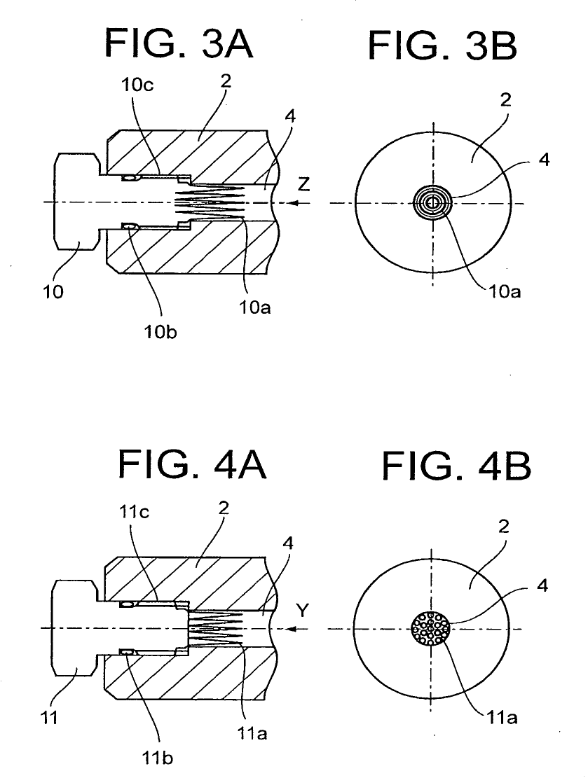

FIG. 3A and FIG. 3B show the second embodiment of the invention, FIG. 3A is an enlarged view of the end part of the common rail, and FIG. 3B is a view in the direction of the arrow Z in FIG. 3A.

In the second embodiment, a pressure reflecting member 10 is screwed fluid-tight into the internal member 2 at an end of the accumulating room 4 where a pressure wave generated in the accumulating room 4 is reflected from (10b is an O-ring for sealing and 10c is the screw part), the pressure reflecting member 10 having a plurality of annular projections 10a projecting toward the accumulating room 4. The annular projections are formed such that each annular projection is concentric around the center of the accumulating room 4.

According to the second embodiment, when a pressure wave of the fuel pressure pulsation generated in the accumulating room 4 propagates in the longitudinal direction of the accumulating room 4 and collides against the annular projections 10a of the pressure reflecting member 10 located at an end of the accumulating room 4, the pressure wave and reflected wave reflected at different portions of the annular projections interfere with each other and energy of resultant wave is decreased, as a result fuel pressure pulsation in the accumulating room 4 is dampened.

### Third Embodiment

FIG. 4A and FIG. 4B show the third embodiment of the invention, FIG. 4 A is an enlarged view of the end part of the common rail, and FIG. 4B is a view in the direction of the arrow Y in FIG. 4A.

In the third embodiment, a pressure reflecting member 11 is screwed fluid-tight into the internal member 2 at an end of the accumulating room 4 where a pressure wave generated in the accumulating room 4 is reflected (11b is an O-ring for sealing and 11c is the screw part), the pressure reflecting member 11 having a plurality of acerose or needlelike projections 11a projecting toward the accumulating room 4.

According to the third embodiment, when a pressure wave of the fuel pressure pulsation generated in the accumulating room 4 propagates in the longitudinal direction of the accumulating room 4 and collides against the acerose or needlelike projections 11a of the pressure reflecting member 11 located at an end of the accumulating room 4, the pressure wave and reflected wave reflected at different portions of the acerose or needlelike projections 11a interfere with each other and energy of resultant wave is decreased, as a result fuel pressure pulsation in the accumulating room 4 is dampened.

### Fourth Embodiment

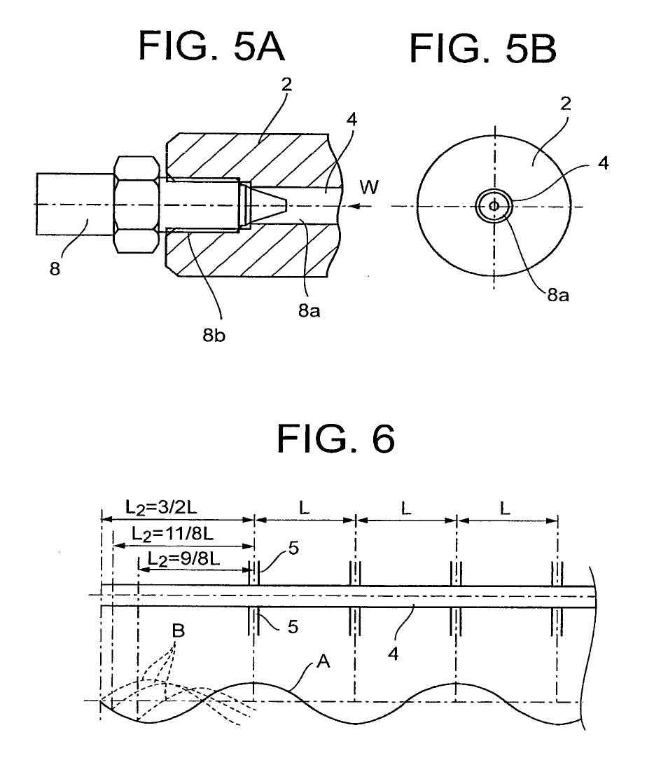

FIG. 5A and FIG. 5B show the fourth embodiment of the invention, FIG. 5 A is an enlarged view of the end part of the common rail, and FIG. 5B is a view in the direction of the arrow W in FIG. 4A.

In the fourth embodiment, the pressure sensor 8 screwed fluid-tight into the internal tube 2 at an end of the accumulating room 4 where a pressure wave generated in the accumulating room 4 is reflected (8b is the screw part) has a tapered projection 8a facing the accumulating room 4.

Also a tapered projection 61 is formed at the end of the relief valve 6 facing the accumulating room 4 as shown in FIG. 1 and FIG. 2.

According to the fourth embodiment, when a pressure wave of the fuel pressure pulsation generated in the accumulating room 4 propagates in the longitudinal direction of the accumulating room 4 and collides against the tapered projection 8a of the pressure sensor 8 or against the tapered projection 61 of the relief valve 6, the wave is reflected irregularly and energy of resultant wave is decreased, as a result fuel pressure pulsation in the accumulating room 4 is dampened.

### Fifth Embodiment

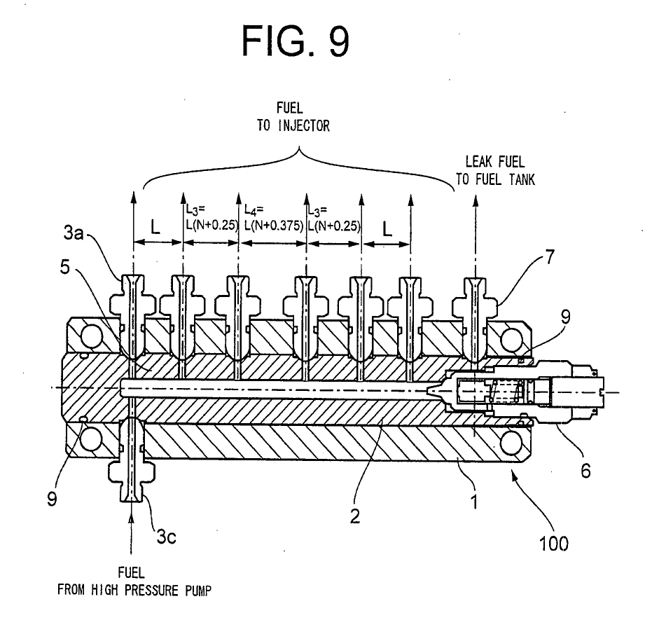

FIG. 9 is a longitudinal sectional view of the common rail of the fifth embodiment of the accumulator fuel injection system for an in-line diesel engine according to the present invention.

In the fifth embodiment, it is preferable that distances such as L₃, L₄ between adjacent high pressure fuel outlets each corresponding to each cylinder are determined such that L₃ and L₄ are in a range of (N+0.25) times to (N+0.375) times the shortest distance L between adjacent high pressure fuel outlets, N being a nonnegative integers.

According to the fifth embodiment, the shortest distance L between adjacent high pressure fuel outlets is taken as a reference distance and other distances between adjacent high pressure fuel outlets is determined to be in a range of (N+0.25) times to (N+0.375) times the shortest distance L, the phase of the pressure wave caused by fuel injection of a certain cylinder differs from that of the pressure wave caused by fuel injection of anther cylinder, and counteraction occurs with each other.

Further, it is possible to combine the second embodiment (FIG. 3), the third embodiment (FIG. 4), and the fourth embodiment (FIG. 5) with the first embodiment shown in FIG. 1-2.

It is also possible to combine the second embodiment (FIG. 3), the third embodiment (FIG. 4), and the fourth embodiment (FIG. 5) with the fifth embodiment shown in FIG. 9.

By combining as above, effect of suppressing fuel pressure pulsation is further increased by combined effect of the first or second or third embodiment with the first or fifth embodiment.

According to the present invention, an accumulator fuel injection system can be provided with which fuel pressure pulsation in the common rail caused by fuel injection can be suppressed by extremely simple means with a low cost system without using an electronic control device and so on.

What is claimed:

1. An accumulator fuel injection system having a common rail for supplying high pressure fuel accumulated in an accumulating room of said common rail to the fuel injection valve of each cylinder through high pressure fuel outlets provided equally spaced along the longitudinal direction of said common rail at predetermined injection timing, wherein the distance from an end of said accumulating room where a pressure wave generated therein is reflected from to a high pressure fuel outlet adjacent to said end is determined in a range of (N+0.25) times to (N+0.375) times the pitch length L of said equally spaced high pressure fuel outlets each corresponding to each cylinder, N being a nonnegative integer.

2. An accumulator fuel injection system having a common rail for supplying high pressure fuel accumulated in an accumulating room of said common rail to the fuel injection valve of each cylinder through high pressure fuel outlets provided equally spaced along the longitudinal direction of said common rail at predetermined injection timing, wherein a distance from an end of said accumulating room where a pressure wave generated therein is reflected from to a high pressure fuel outlet adjacent to said end is 1/2 times the pitch length L of said equally spaced high pressure fuel outlets each corresponding to each cylinder, i.e. L₁=½·L, and a distance L₂ from the other end of said accumulating room to a high pressure fuel outlet adjacent to said other end is 3/2 times said pitch length L, i.e. L₂= 3/2·L.

3. An accumulator fuel injection system having a common rail for supplying high pressure fuel accumulated in an accumulating room of said common rail to the fuel injection valve of each cylinder through high pressure fuel outlets provided equally spaced along the longitudinal direction of said common rail at predetermined injection timing, wherein a pressure reflecting member having a plurality of projections is provided at an end part of said accumulating room where a pressure wave generated therein is reflected from such that said projection is directed toward said accumulating room.

4. An accumulator fuel injection system according to claim 3, wherein said pressure reflecting member has a plurality of annular projections formed such that each annular projection is concentric around the center of the accumulating room and faces toward the accumulating room.

5. An accumulator fuel injection system according to claim 3, wherein said pressure reflecting member has a plurality of acerose or needlelike projections formed such that each projection faces toward the accumulating room.

6. An accumulator fuel injection system having a common rail for supplying high pressure fuel accumulated in an accumulating room of said common rail to the fuel injection valve of each cylinder through high pressure fuel outlets provided equally spaced along the longitudinal direction of said common rail at predetermined injection timing, wherein a relief valve is provided at an end of the accumulating room for adjusting the pressure therein and a pressure sensor is provided at the other end of the accumulating room for detecting the pressure therein, and a tapered portion projecting toward the accumulating room is formed to one or both of the relief valve and the pressure sensor.

7. An accumulator fuel injection system having a common rail for supplying high pressure fuel accumulated in an accumulating room of said common rail to the fuel injection valve of each cylinder through high pressure fuel outlets at predetermined injection timing, wherein said high pressure fuel outlets each corresponding to each cylinder are positioned unequally spaced such that at least one of distances between adjacent high fuel pressure outlets is determined in a range of (N+0.25) times to (N+0.375) times the shortest distance L between adjacent high pressure fuel outlets, N being a nonnegative integers.
